(19) United States
(12) Patent Application Publication
(10) Pub. No.: US 2019/0078560 A1
(43) Pub. Date: Mar. 14, 2019

(54) Quantum Laser-Driven Engine

(71) Applicant: Corey Reaux-Savonte, London (GB)

(72) Inventor: Corey Reaux-Savonte, London (GB)

(21) Appl. No.: 16/103,362

(22) Filed: Aug. 14, 2018

(30) Foreign Application Priority Data
Aug. 16, 2017 (GB) GB1713135.0

(51) Int. Cl. F03H 3/00; F03H 99/00; H02S 40/42

(52) U.S. Cl. CPC F03H 3/00; H02S 40/42; F03H 99/00

(57) ABSTRACT

An engine that uses photons to create an Internal Directional Pressure Imbalance, resulting in thrust.

### FIELD OF THE INVENTION

The disclosed embodiments relate to physics and engineering.

### BACKGROUND

Most engines require propellant to create thrust, based on the incorrect law of “every action has an equal and opposite reaction”. This is how you create a working engine using photons to create thrust.

### SUMMARY

The disclosed invention is an engine that uses photons to create a pressure imbalance, in turn creating thrust.

In an aspect of the invention, photons are used to create an Internal Directional Pressure Imbalance (IDPI), creating thrust.

In another aspect of the invention, the engine can use heat and/or solar energy to recharge itself.

In another aspect of the invention, the engine can be used as a probe.

### DESCRIPTION OF DRAWINGS

FIG. 1

An example of an engine setup.

101—Dark walled vacuum chamber.
102—Laser.
103—Laser beam.
104—Thermoelectric generator/cooler.
105—Additional cooling unit.
106—Solar panels.
107—Rechargeable power source.
108—Wire tunnels.

### DETAILED DESCRIPTION OF EMBODIMENTS

Reference will now be made in detail to embodiments. In the following detailed description, numerous specific details are set forth in order to provide a thorough understanding of the present invention. However, it will be apparent to one of ordinary skill in the art that the present invention may be practiced without these specific details. In other instances, well-known methods, procedures, components and networks have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The term “engine” can also include the body of the vehicle within which the engine is situated. The term “laser” can also be taken to mean photon source.

The term “chamber” can be taken to mean any measurable compartment with at least two sides anywhere within the full height, width, and length of the engine's shape.

The terms “wall” and “end wall” refer to any side of a chamber, regardless of size or alignment.

The term “internal” refers to anywhere within the full height, width and length of the engine's shape.

The various applications and uses of the invention that may be executed may use at least one common component capable of allowing a user to perform at least one task made possible by said applications and uses. One or more functions of the component may be adjusted and/or varied from one task to the next and/or during a respective task. In this way, a common architecture may support some or all of the variety of tasks.

Unless clearly stated, the following description is not to be read as:
the assembly, position or arrangement of components;
how components are to interact; or
the order in which steps must be taken to compose the present invention.

Attention is now directed towards embodiments of the invention.

This engine relies on one thing—Internal Directional Pressure Imbalance (IDPI). By creating pressure internally that is greater in one direction than the opposing direction, within an environment where the total of all external resistance being applied to the engine is less than the difference of the directional pressures (such as in a vacuum), the engine is forced to move in the direction of greatest pressure.

For example, if pressure moving left within the engine is equal to 10, and pressure moving right is equal to 4, the difference is 6, and 6 is the value of the thrust. If the external resistance value is 6 or greater, the engine can't move because the thrust is being equalised or dominated by external resistance. However, if the external resistance value is lower than 6, the thrust becomes dominant, and the engine moves left. The greater the difference between thrust and resistance, the faster the engine moves.

If used on the ground, the movement of matter created when impacted upon by photons would usually be equalised or dominated by friction or air resistance in the opposite direction due to photon impact being so weak, but in an environment with no resistance—such as the vacuum of space—there is nothing preventing movement because there is nothing working against the movement.

This disproves the law “every action has an equal and opposite reaction”, which is why it works. Pressure cannot be exerted upon energy, so, when a photon impacts upon matter, the matter cannot exert pressure upon the photon in retaliation.

Now, creating a propellantless engine requires the use of photons, which are used because they naturally move without the need of pressure being exerted upon them. The sole requirements for this engine are a photon source, a chamber in which photons impact opposing walls at different average speeds, and a power source. The easiest way to do this is using a chamber which has vacuum space between one end wall and a medium, and no vacuum space between a medium and the opposing end wall, and firing photons from a photon source (such as a laser) in the direction of the vacuum space. All photons travelling through the vacuum travel at light speed at the point of impact, and exert the maximum amount of pressure possible against the end wall, and the average speed will be light speed, while some photons travelling through the medium in the opposing direction will be travelling slower than light speed at the point of impact if it is a direct matter-to-matter transfer, will create an impact at an average speed of less than light speed, and will contain less energy due to some being lost as they passed through the medium, creating less than the maximum amount of pressure possible. This is how the IDPI is created. The engine will then move in the direction in which the pressure being created is the greatest, which may not always be in the direction of the vacuum, as this is largely dependent on photon build up, reflection, refraction, and any other factors that can change the behaviour of a photon.

With the IDPI created, the engine itself can be improved using additional components. Each of the following is an example of different possible embodiments, which may be used individually or in combination with any other embodiment(s):
Dark Walled Chamber—Using a chamber with dark coloured walls reduces reflection, which, in turn, reduces any pressure created in the opposing direction due to the impact of the reflected photons.
Rechargeable Power Source—By using a rechargeable power source combined with a technique for on-the-go charging, the engine can run until the power source is no longer capable of holding a charge.
   Thermoelectric Generator (TEG)—Photon impact will generate heat. Using a TEG, the heat can be used to generate electricity and recharge the power source.
   Solar Panels—Solar panels can use solar energy to generate electricity and recharge the power source.
Solar Panels (Direct)—Solar panels can use solar energy to directly power the laser.
Thermoelectric Cooling (TEC)—A TEC can be used to draw heat away from end walls to prevent overheating/burning.
   Additional Cooling—An additional cooling unit, such as a fan or water tank, can be attached to the TEC to better help draw heat away.

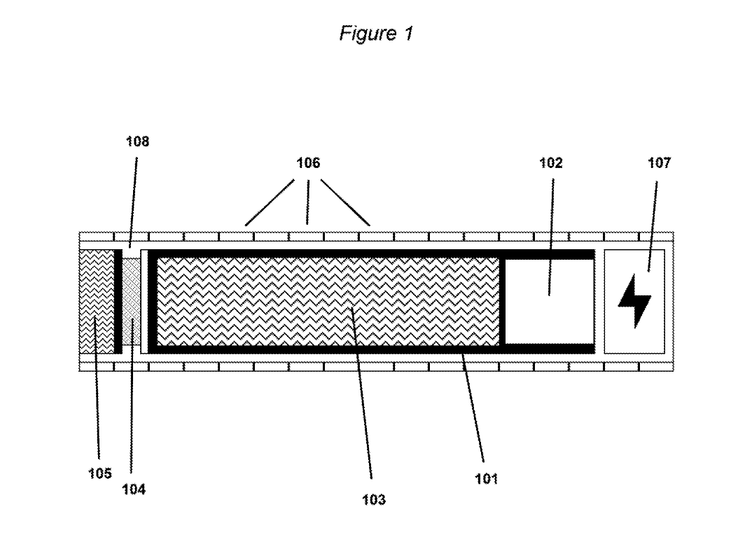

FIG. 1 is an example setup featuring all the additional components mentioned above. Laser 102 is firing laser beam 103 within dark walled vacuum chamber 101. The photons of the laser beam impacts on and heats the end wall. The heat generated is used by TEG 104 to generate electricity, which is sent to rechargeable power source 107 via wire tunnels 108. TEG 104, also doubling as a TEC, cools the end wall, using additional cooling unit 105 to help draw the heat away. Solar panels 106 use solar energy to generate electricity and also pass it to rechargeable power source 107 via wire tunnels 108.

In FIG. 1, the IDPI is created via the photons travelling through the vacuum chamber in one direction, and photons bouncing around within the laser medium—some of them moving in a direction opposite to the direction of the laser beam.

Further additional components can be added to use the engine as a probe. Each of the following is an example of different possible embodiments, which may be used individually or combined with other embodiment(s).
Receiver—To allow data to be sent to the engine.
Transmitter—To send data from the engine.
Transceiver—To send data to and receive data from the engine.
Camera—To capture images.
Microphone—To record sound.
Barometer—To detect pressure.
Thermometer—To detect temperature.

In order to remotely steer the engine, an embodiment which includes one or more additional mechanisms need to be implemented. Example embodiments are:
Multi-Laser (ML)—An ML embodiment sees at least two lasers in a single engine, pointing in different directions, used. A Laser can then be activated when necessary to drive, turn, or move sideways.
Swivel Laser (SL)—An SL embodiment sees a laser with the ability to turn within the engine, allowing it to fire in different directions when necessary.
Swivel Engine (SE)—An SE embodiment requires the engine to be attached to another object upon which it can be turned, and fired in the required direction when necessary.
Multi-Engine (ME)—An ME embodiment sees two or more engines, pointing in different directions, working together. The required engine(s) is then activated when necessary.

Regardless of the embodiment used, a type of receiver is required in order to receive signals to activate the turning and/or firing mechanisms, and a type of transmitter is required in order to transmit data back to the controller so that the controller can track its movement.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. An engine, comprising:
one or more photon sources;
one or more chambers; and
one or more power sources;
wherein the one or more photon sources fire photons against opposing walls, either directly or indirectly, within a chamber, at different average speeds upon impact, to create an Internal Directional Pressure Imbalance with a greater pressure difference than the external resistance, creating thrust.

2. The engine of claim 1, comprising one or more dark coloured walls to reduce photon reflection.

3. The engine of claim 1, comprising one or more rechargeable power sources to power a photon source.

4. The engine of claim 1, comprising one or more thermoelectric generators to recharge a rechargeable power source.

5. The engine of claim 1, comprising one or more solar panels to recharge a rechargeable power source.

6. The engine of claim 1, comprising one or more solar panels to directly power a photon source.

7. The engine of claim 1, comprising one or more thermoelectric coolers to draw heat away from a wall upon which photons impact.

8. The engine of claim 1, comprising one or more additional cooling units to better help a thermoelectric cooler draw heat away from a wall.

9. The engine of claim 1, comprising one or more components to send and/or receive data.

10. The engine of claim 1, comprising one or more components to record data from the surrounding environment.

11. The engine of claim 1, comprising:
one or more components to send and receive data; and
one or more steering mechanisms which rely on:
multiple photon sources pointing in different directions; or
one or more other engines pointing in a different direction; or
the swivelling of one or more components; or
the swivelling of one or more engines, including this engine itself; or
one or more of the above;
wherein:
a controller in a remote location can send signals to the one or more engines to activate a component when necessary for steering; and
the one or more engines can send data back to the controller so the controller can track movement.

12. A method of creating thrust, the method comprising firing photons from one or more photon sources towards opposing walls at different average speeds upon impact to create an Internal Directional Pressure Imbalance.

13. The use of photons in a chamber to create an Internal Directional Pressure Imbalance, wherein the internal pressure difference between opposing directions is greater than the external resistance it faces, creating thrust.
